(19) United States
(12) Patent Application Publication
(10) Pub. No.: US 2026/0359370 A1
(43) Pub. Date: Nov. 12, 2026

(54) DETERMINING INFORMATION ACQUISITION PRIORITIES BASED ON AGE-OF-INFORMATION AND DEMAND

(71) Applicant: International Business Machines Corporation, Armonk, NY (US)

(72) Inventors: Mari Abe FUKUDA, Tokyo (JP); Kenichi TAKASAKI, Shibuya (JP); Mingqin XU, Tokyo (JP); Sanehiro FURUICHI, Setagaya-ku (JP); Shoichiro WATANABE, Tokyo (JP); Takashi ISHIKAWA, Arakawa-ku (JP); Tomonori SUGIURA, Yokohama (JP)

(21) Appl. No.: 19/203,594

(22) Filed: May 9, 2025

(51) Int. Cl. G06F 16/9537

(52) U.S. Cl. CPC G06F 16/9537

(57) ABSTRACT

In some implementations, a computer system may receive an age-of-information and a demand for information to be utilized in an application, and may determine a context for the information based on external factors that influence variation of the information. The computer system may calculate a gain value for the information based on the age-of-information, and may calculate an information entropy for the information based on the context, information acquisition methods, and an information fluctuation probability associated with the context. The computer system may calculate, based on the gain value and the information entropy, an information value for each of the information acquisition methods to generate information values, and may determine, based on the demand and each of the information values, a priority score for each of the information acquisition methods to generate priority scores. The computer system may perform actions based on the priority scores.

### BACKGROUND

This disclosure relates to information acquisition, and more specifically, to a determining information acquisition priorities based on age-of-information and demand.

Information acquisition priorities involve a structured approach to determine what information is most important to gather, based on its relevance to specific needs and goals. This process often involves defining the scope of information needed, establishing priorities based on importance and urgency, and developing strategies for data collection and management.

### SUMMARY

Some implementations described herein relate to a method. The method may include receiving an age-of-information and a demand for information to be utilized in an application, and determining a context for the information based on one or more external factors that influence variation of the information. The method may include calculating a gain value for the information based on the age-of-information, and calculating an information entropy for the information based on the context, a plurality of information acquisition methods, and an information fluctuation probability associated with the context. The method may include calculating, based on the gain value and the information entropy, an information value for each of the plurality of information acquisition methods to generate a plurality of information values, and determining, based on the demand and each of the plurality of information values, a priority score for each of the plurality of information acquisition methods to generate a plurality of priority scores. The method may include performing one or more actions based on the plurality of priority scores.

Some implementations described herein relate to a computer system. The computer system may include a processor set, one or more computer-readable storage media, and program instructions stored on the one or more computer-readable storage media to cause the processor set to perform operations. The operations may include receiving an age-of-information and a demand for information to be utilized in an application, wherein the information includes geographic information and time information associated with events. The operations may include determining a context for the information based on one or more external factors that influence variation of the information, and calculating a gain value for the information based on the age-of-information. The operations may include calculating an information entropy for the information based on the context, a plurality of information acquisition methods, and an information fluctuation probability associated with the context, and calculating, based on the gain value and the information entropy, an information value for each of the plurality of information acquisition methods to generate a plurality of information values. The operations may include determining, based on the demand and each of the plurality of information values, a priority score for each of the plurality of information acquisition methods to generate a plurality of priority scores, and performing one or more actions based on the plurality of priority scores.

Some implementations described herein relate to a computer program product. The computer program product may include one or more computer-readable storage media and program instructions stored on the one or more computer-readable storage media to perform operations. The operations may include receiving an age-of-information and a demand for information to be utilized in an application, wherein the age-of-information is calculated based on a time elapsed since a last update of the information. The operations may include determining a context for the information based on one or more external factors that influence variation of the information, and calculating a gain value for the information based on the age-of-information. The operations may include calculating an information entropy for the information based on the context, a plurality of information acquisition methods, and an information fluctuation probability associated with the context, and calculating, based on the gain value and the information entropy, an information value for each of the plurality of information acquisition methods to generate a plurality of information values. The operations may include determining, based on the demand and each of the plurality of information values, a priority score for each of the plurality of information acquisition methods to generate a plurality of priority scores, and performing one or more actions based on the plurality of priority scores.

### BRIEF DESCRIPTION OF THE DRAWINGS

FIG. 1 is a diagram of an example computing environment for determining information acquisition priorities based on age-of-information and demand, as described herein.

FIGS. 2A-2G are diagrams of an example associated with determining information acquisition priorities based on age-of-information and demand.

FIG. 3 is a flowchart of an example process associated with determining information acquisition priorities based on age-of-information and demand.

### DETAILED DESCRIPTION

The following detailed description of example implementations refers to the accompanying drawings. The same reference numbers in different drawings may identify the same or similar elements.

Geospatial events, such as wildfires or floods, require timely and accurate event information to ensure public safety and efficient responses. However, current methods of gathering information about such events, including satellite imaging, roadside cameras, and crowd sourcing, have limitations in terms of coverage, accuracy, and reliability. Furthermore, an age-of-information of the information and a demand for the information can vary greatly, making it challenging to prioritize the gathering of new information. Creating dynamic maps utilizing event information is hindered by several issues associated with acquiring the event information. For example, in-vehicle devices may not always provide video, continuous monitoring by roadside cameras may be limited to specific areas, and manually input information is prone to quality issues. Satellite imagery, while useful, has limitations in terms of granularity and update frequency due to hardware constraints, such as power and wireless bandwidth. As a result, there is no definitive method for obtaining information about geospatial events, and to determine the utility of dynamic maps depicting geospatial events.

Specifically, there is a lack of a mechanism to determine priorities for which information should be acquired and updated, and what methods should be used to acquire the information. The lack of prioritization can lead to gathering information that is no longer relevant or failing to gather information that is urgently needed. The problem is exacerbated by the fact that different methods of gathering information, such as vehicles, drones, and satellites, have varying capabilities and limitations, making it challenging to determine which method to use for gathering particular information. Thus, current techniques for managing information acquisition consume computing resources (e.g., processing resources, memory resources, communication resources, and/or the like), networking resources, and/or the like associated with failing to prioritize which information should be acquired and updated, gathering useless information that is no longer relevant based on failing to prioritize which information should be acquired, failing to gather information that is urgently needed based on failing to prioritize which information should be acquired, and/or the like.

Some implementations described herein provide a computer system for determining information acquisition priorities based on age-of-information and demand. For example, the computer system may receive an age-of-information and a demand for information to be utilized in an application, and may determine a context for the information based on one or more external factors that influence variation of the information. The computer system may calculate a gain value for the information based on the age-of-information, and may calculate an information entropy for the information based on the context, a plurality of information acquisition methods, and an information fluctuation probability associated with the context. The computer system may calculate, based on the gain value and the information entropy, an information value for each of the plurality of information acquisition methods to generate a plurality of information values, and may determine, based on the demand and each of the plurality of information values, a priority score for each of the plurality of information acquisition methods to generate a plurality of priority scores. The computer system may perform one or more actions based on the plurality of priority scores.

In this way, the computer system determines information acquisition priorities based on age-of-information and demand. For example, the computer system may optimize information acquisition by reducing latency and increasing the relevance of the acquired information. The computer system may scale back unnecessary information gathering operations, thus reducing data transmission overhead and conserving bandwidth. By calculating priority scores for different information acquisition methods, the computer system may enable more efficient allocation of system resources, such as processing power and memory. Thus, the computer system conserves computing resources, networking resources, and/or the like that would otherwise have been consumed by failing to prioritize which information should be acquired and updated, gathering useless information that is no longer relevant based on failing to prioritize which information should be acquired, failing to gather information that is urgently needed based on failing to prioritize which information should be acquired, and/or the like.

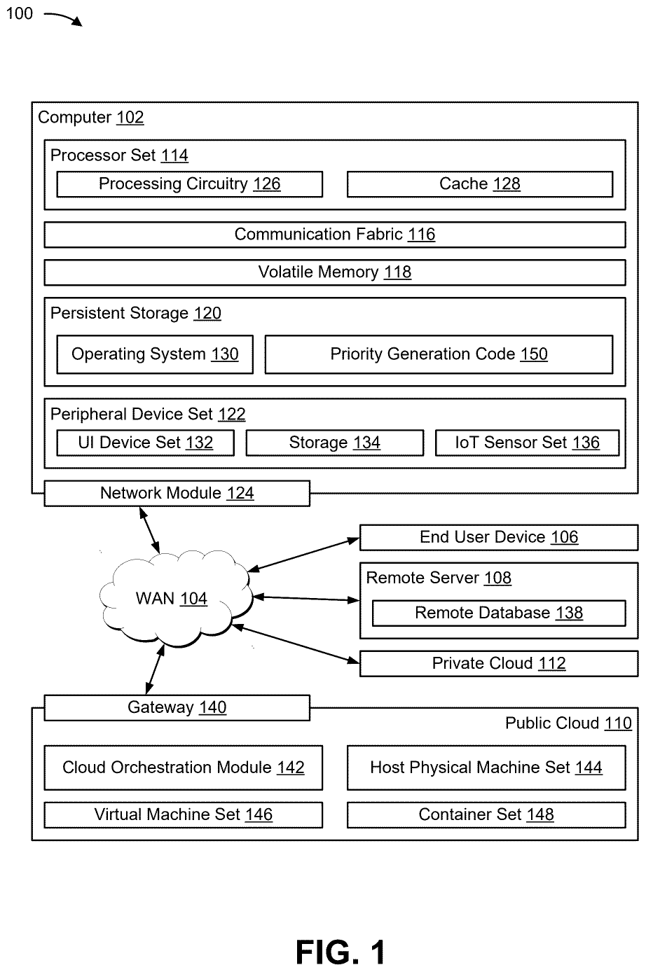

FIG. 1 is a diagram of an example computing environment 100 for determining information acquisition priorities based on age-of-information and demand, as described herein.

Computing environment 100 contains an example of an environment for the execution of at least some of the computer code involved in performing the inventive methods, such as priority generation code 150. In addition to priority generation code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and priority generation code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in priority generation code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

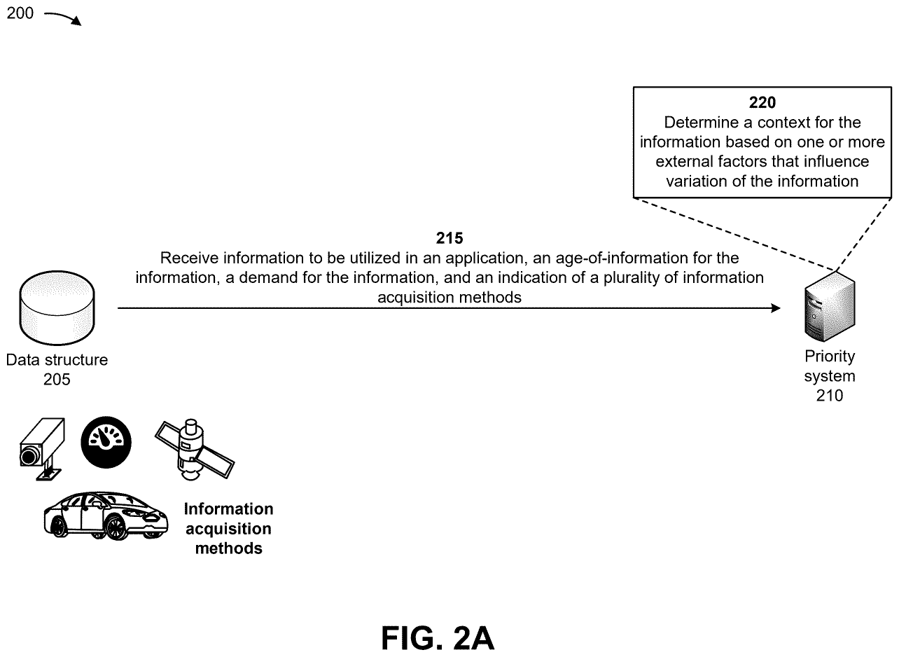

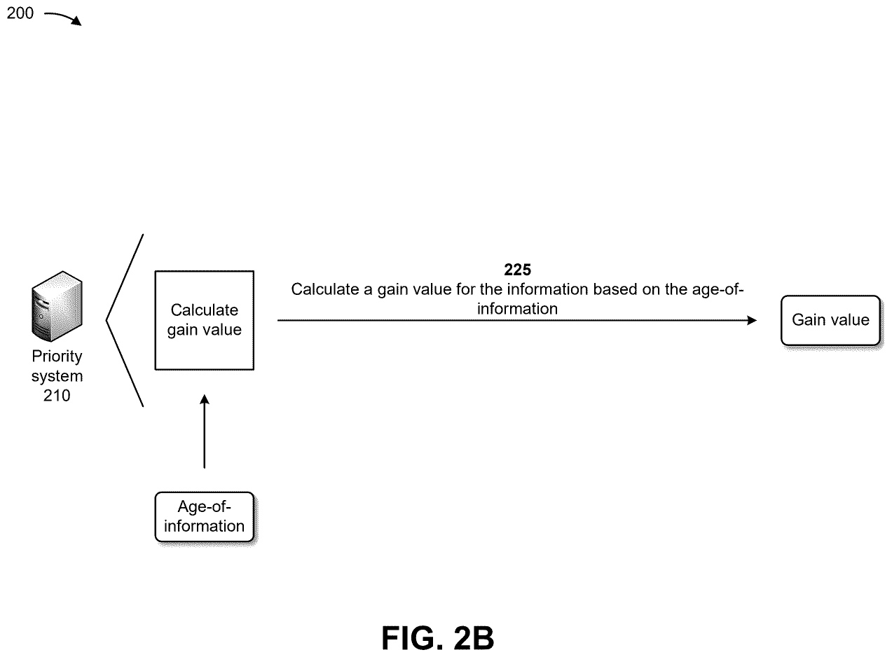

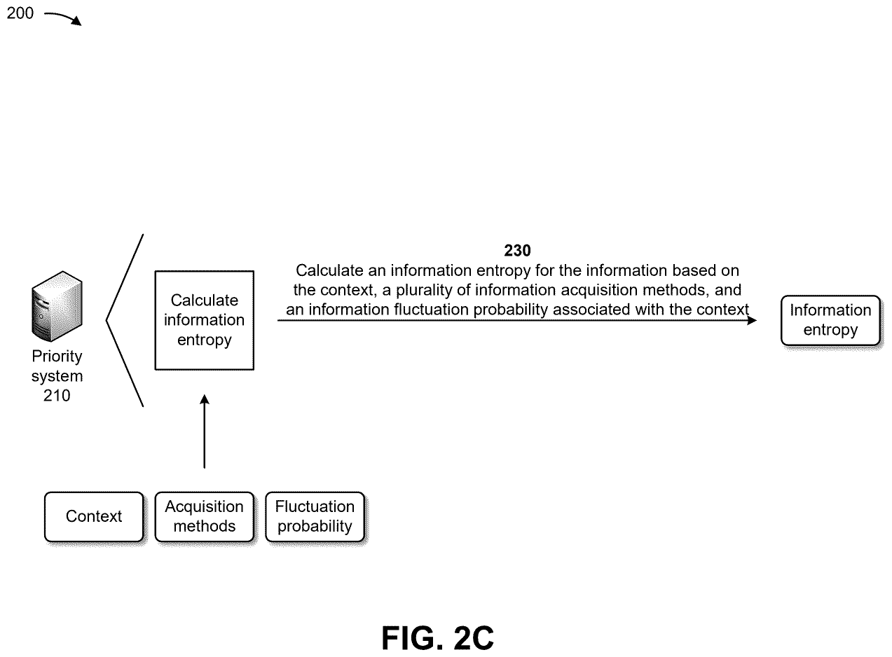

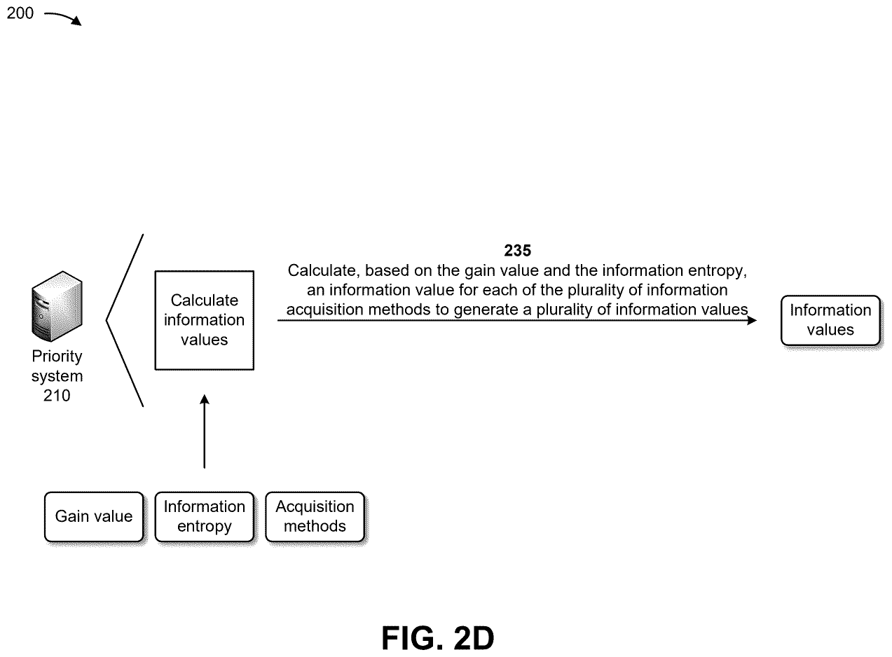

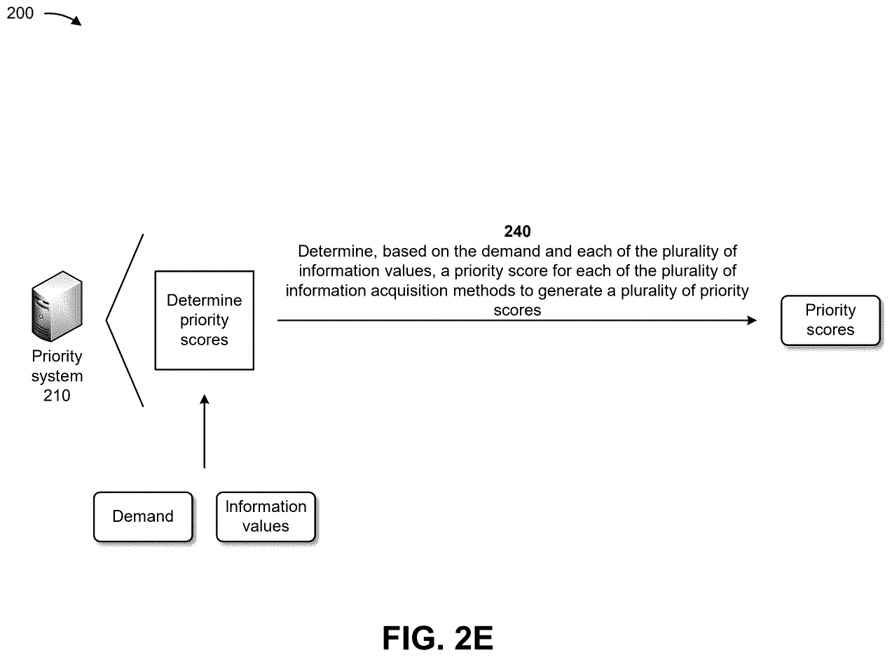

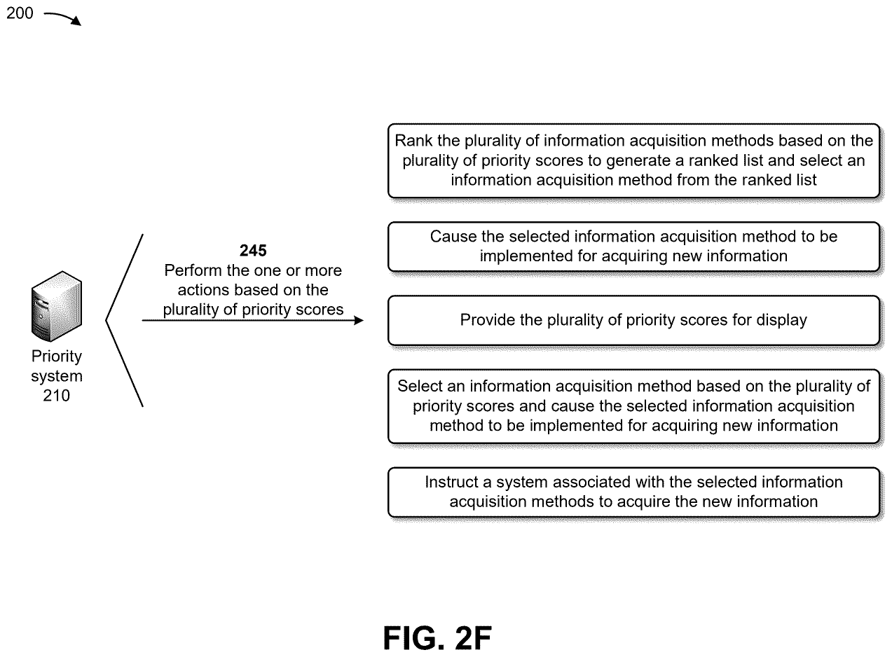

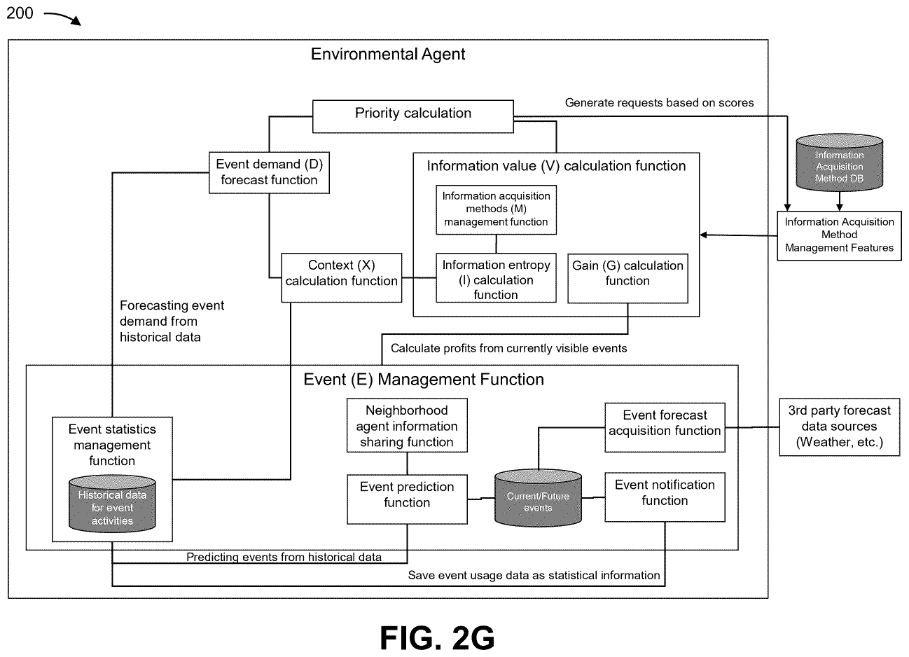

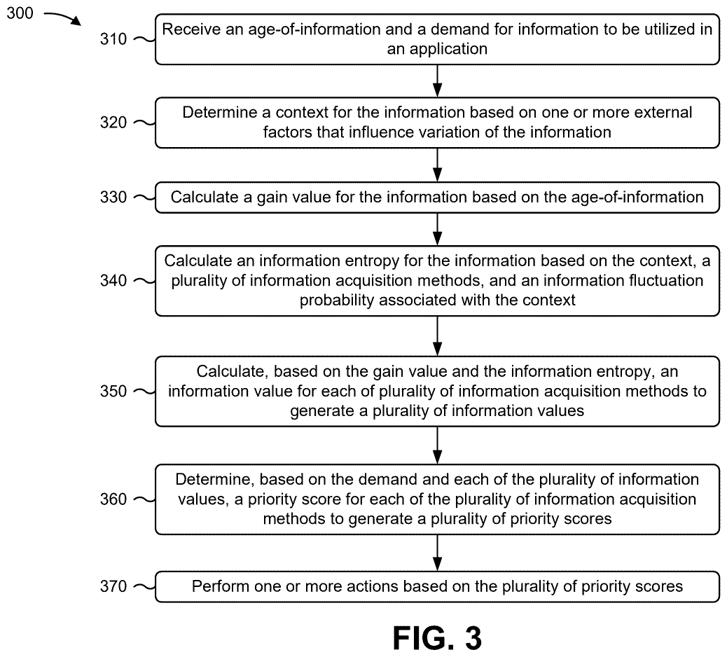

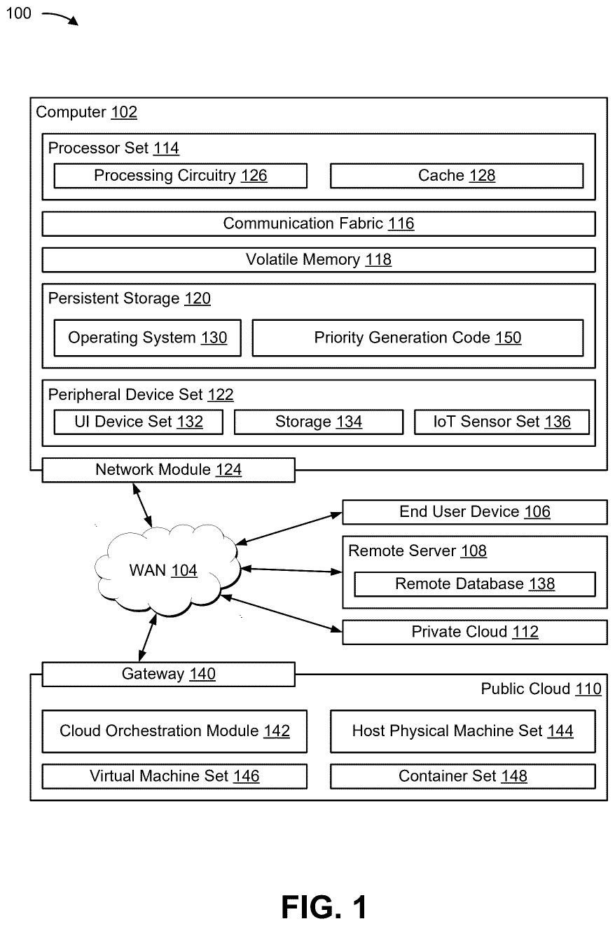

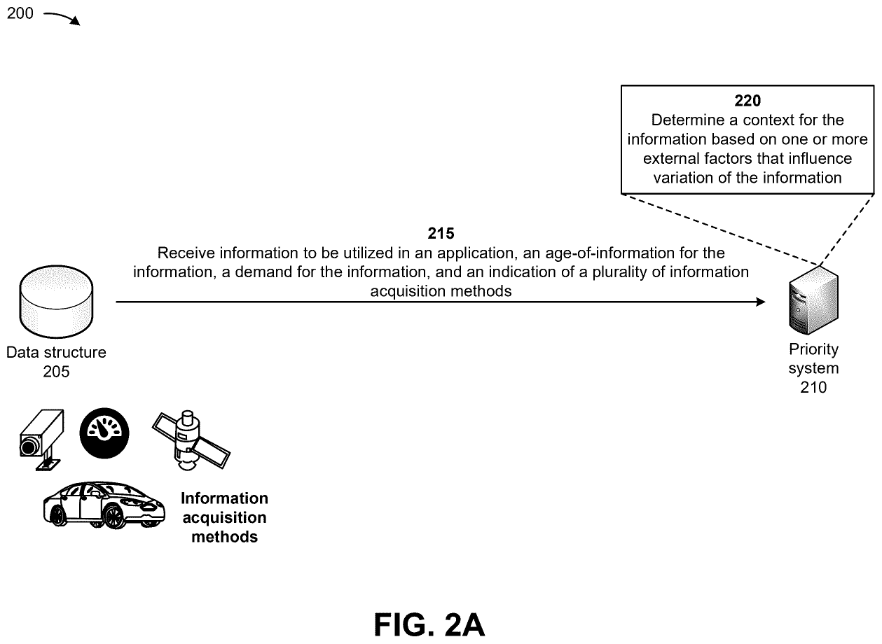

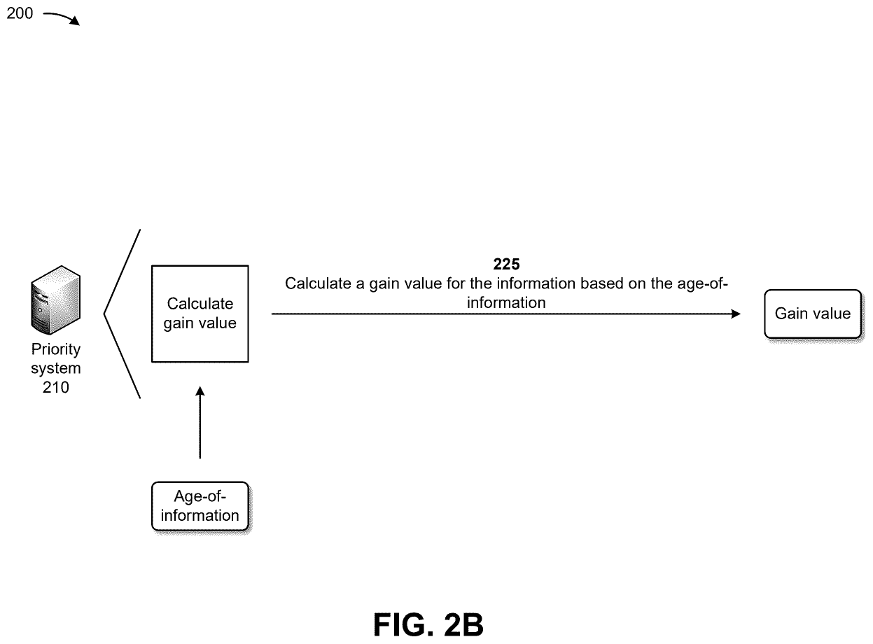

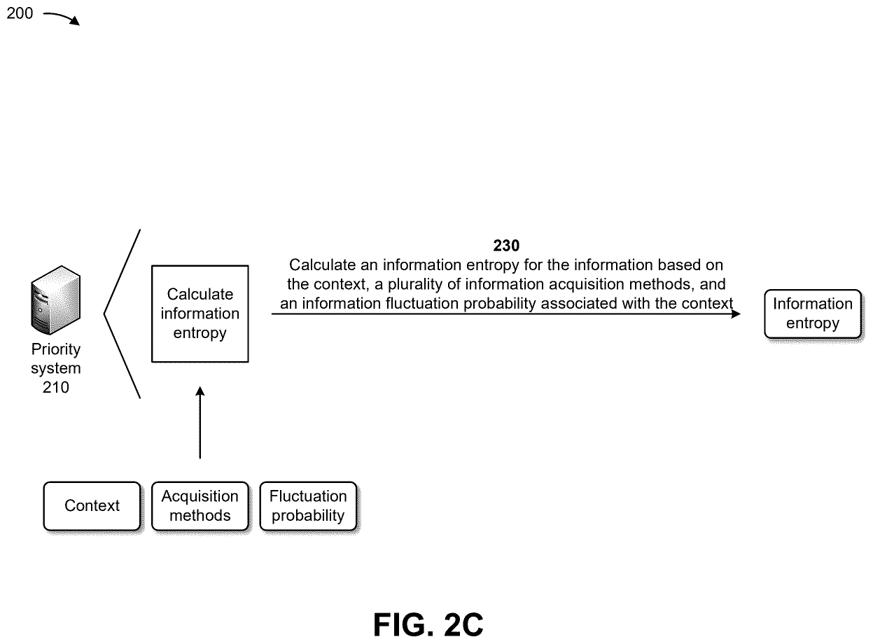

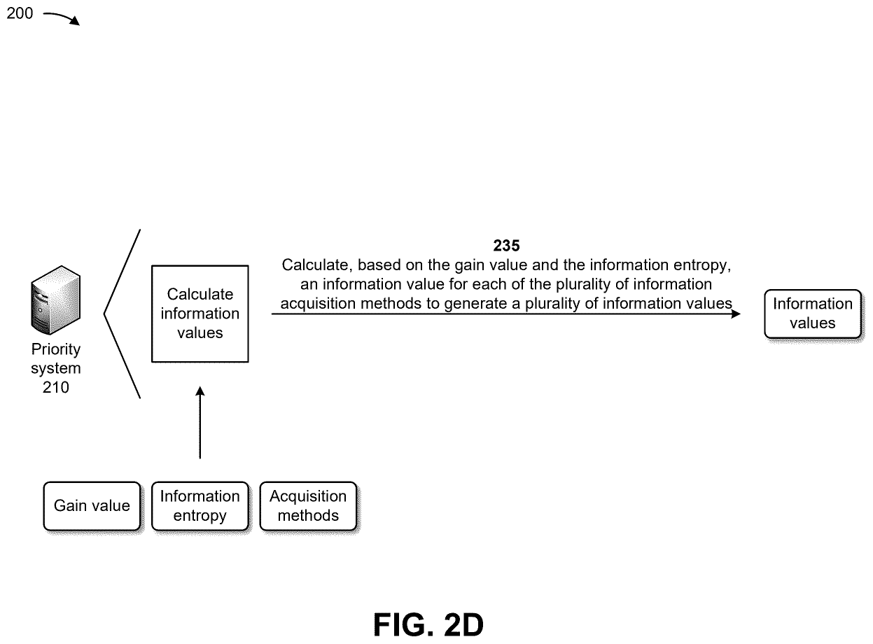

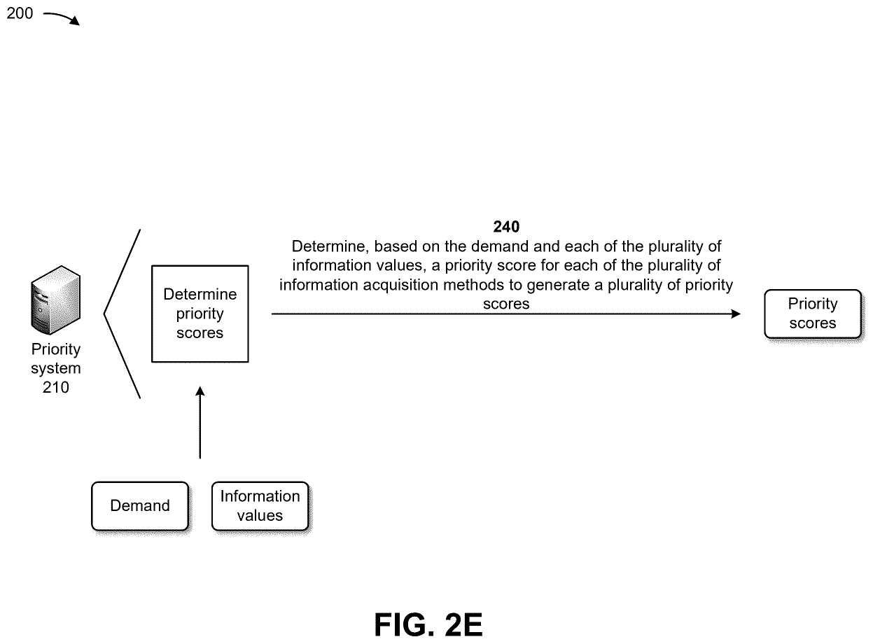

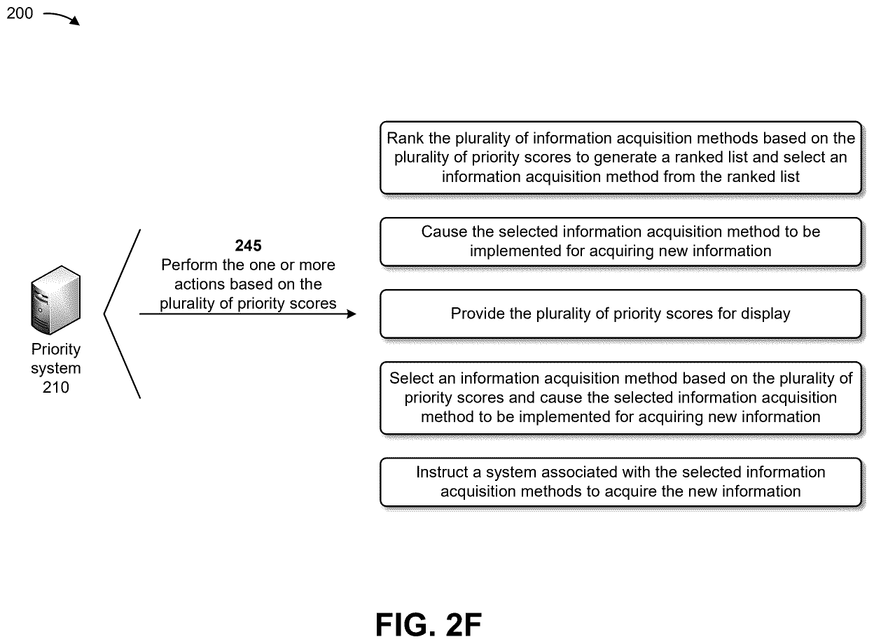

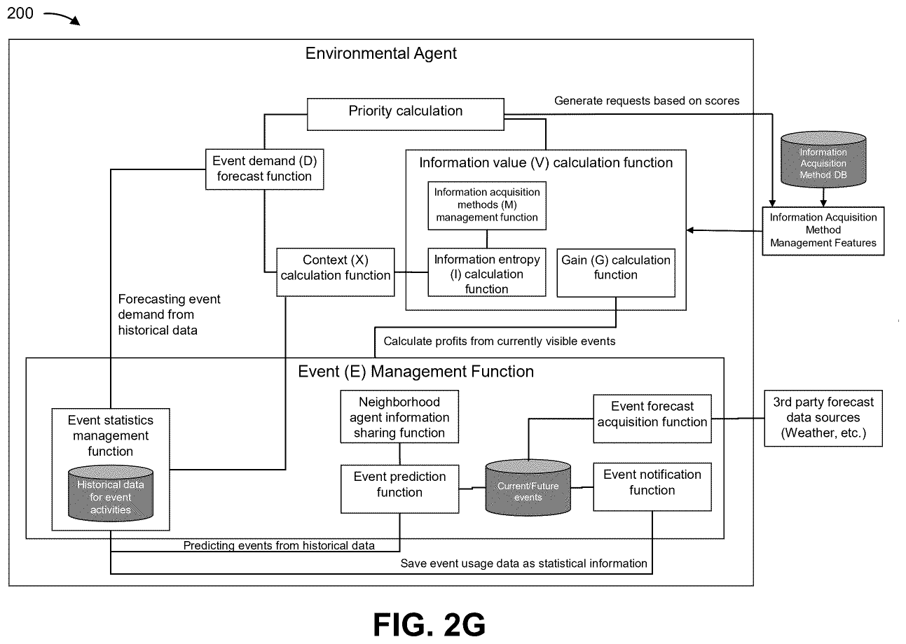

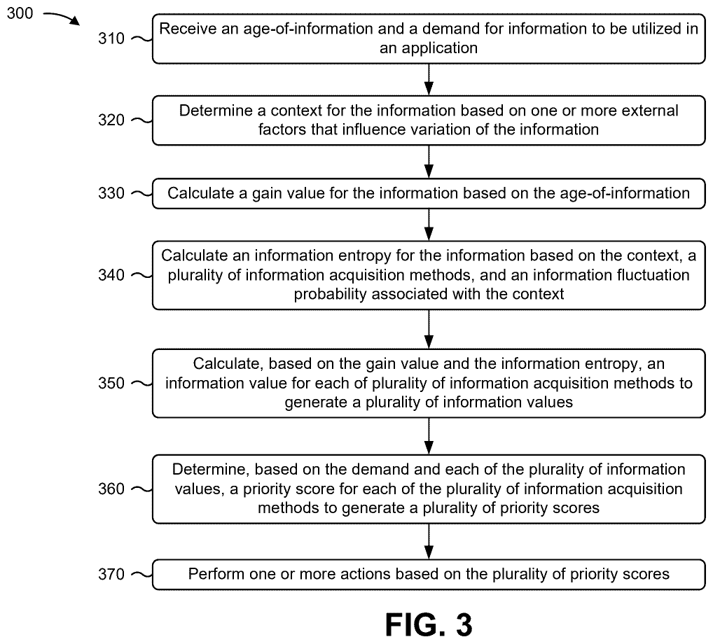

The code included in the priority generation code 150 typically includes at least some of the computer code involved in performing one or more operations described herein, such as the operations of implementation 200 in FIGS. 2A-2G and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (A Pls). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2G are diagrams of an example 200 associated with determining information acquisition priorities based on age-of-information and demand. As shown in FIGS. 2A-2G, the example 200 includes a data structure 205 associated with a plurality of information acquisition methods and a priority system 210. The data structure 205 may include a database, a table, a list, and/or the like that stores information retrieved by the plurality of information acquisition methods. The plurality of information acquisition methods may include one or more of a satellite-based information acquisition method, a drone-based information acquisition method, an autonomous vehicle-based information acquisition method, a traffic infrastructure-based information acquisition method, and/or the like. The priority system 210 may include a system that determines information acquisition priorities based on age-of-information and demand for the information. Further details of the data structure 205, the plurality of information acquisition methods, and the priority system 210 are provided elsewhere herein. Although FIGS. 2A-2G show a single data structure 205 associated with the priority system 210, in some implementations the priority system 210 may be associated with multiple data structures 205.

As shown in FIG. 2A, and by reference number 215, the priority system 210 may receive information to be utilized in an application, an age-of-information for the information, a demand for the information, and an indication of a plurality of information acquisition methods. For example, the data structure 205 may receive and store the information to be utilized in the application from the plurality of information acquisition methods. In some implementations, the information may include event information associated with events (e.g., past, present, and future). An event may be associated with geographic information (e.g., location information, range information, and/or the like) and time information, and may be predicted from satellite images, video recordings, reported by witnesses, and/or the like. In one example, an event may include an event that is utilized in an intelligent transportation system. In some implementations, the information may include geographic information and time information associated with events. The age-of-information may be calculated based on a time elapsed since a last update or acquisition of the information. The demand may include a demand for an event for each space and time, and may be calculated based on a number of times that the information (e.g., an event) has been referenced in a past time period. The plurality of information acquisition methods may include one or more of a satellite-based information acquisition method, a drone-based information acquisition method, an autonomous vehicle-based information acquisition method, a traffic infrastructure-based information acquisition method, and/or the like. In some implementations, the priority system 210 can handle various event types, including wildfires, weather, natural disasters, and traffic. For example, the priority system 210 may utilize vehicles to acquire information about traffic conditions, drones to acquire information about weather conditions, and satellites to acquire information about natural disasters and wildfires.

In some implementations, the priority system 210 may continually receive the information, the age-of-information for the information, and the demand for the information from the data structure 205 and/or the plurality of information acquisition methods. Alternatively, or additionally, the priority system 210 may periodically receive the information, the age-of-information for the information, and the demand for the information from the data structure 205 and/or the plurality of information acquisition methods. Alternatively, or additionally, the priority system 210 may receive the information, the age-of-information for the information, and the demand for the information from the data structure 205 and/or the plurality of information acquisition methods based on one or more requests for the information, the age-of-information for the information, and the demand for the information.

In some implementations, the priority system 210 may utilize an agent-based data platform with multiple environmental agents a_{x,t} that are spatially and temporally aware. For example, each environmental agent a_{x,t} may store and process information (e.g., including events) for a specific time period and space (e.g., location) and that is uniquely determined by time t and location x. An environmental agent aₓt may process multiple events (e) and different event types (E) (e.g., weather, natural disasters, traffic, and/or the like). Further details of an environmental agent a_{x,t} are provided below in connection with FIG. 2G.

As further shown in FIG. 2A, and by reference number 220, the priority system 210 may determine a context for the information based on one or more external factors that influence variation of the information. For example, since a value of the information may vary depending on a situation of an environment (e.g., an event), the context (X) for the information may be utilized to determine the situation. The context (X) for the information may include a class that represents a situation according to an event type (e.g., if the event type is weather, the situation may include sunny, stormy, snowing, and/or the like). The external factors that influence variation of the information may include a time-space reachability of the information, the demand for the information, and the plurality of information acquisition methods. The priority system 210 may determine the context (X) for the information based on the time-space reachability of the information, statistical information associated with the information, and the one or more external factors.

In some implementations, the external factors that influence the variation of information may include but are not limited to environmental conditions, geographic location, time, and the nature of the event. For example, a wildfire event's context can be influenced by wind speed, humidity, and temperature, which can affect the spread and intensity of the fire. Similarly, traffic information can vary based on the time of day, weather conditions, and road construction activities. These external factors may be used to determine the context (X) for the information, as they provide a comprehensive understanding of the situation and its potential changes over time. By considering these factors, the priority system 210 may ensure that the context is accurately defined, leading to more precise calculations of gain value and information entropy.

As shown in FIG. 2B, and by reference number 225, the priority system 210 may calculate a gain value for the information based on the age-of-information. For example, the priority system 210 may calculate the gain value for the information based on the age-of-information (e.g., in seconds, minutes, hours, days, or weeks) to quantify a potential benefit of acquiring new information. The gain value may represent an expected improvement in the accuracy or relevance of the information, given a current age of the information. The priority system 210 may define a gain function that maps the age-of-information to the gain value. The gain function may include various forms, such as a linear function, an exponential function, or a logarithmic function, depending on specific characteristics of the information and the application. Alternatively, a more complex gain function can be defined based on the specific requirements of the application. For example, if the information is related to a rapidly changing environment, a gain function with a higher slope can be used to reflect the increasing uncertainty and potential benefit of acquiring new information. In one example, the gain value (G) may include a value determined based on an environmental agent a_{x,t}, an event type (E), the age-of-information (AoI), and an event (e) according to the following equation:

$$G ( {a}_{x , t} , E ) = {\sum }_{i = 0}^{i \_ max} \{ AoI ( {e}_{i} ) \}$$

where the greater the gain value, the older the information.

Environmental agents in a spatiotemporal neighborhood of a_{x,t} may be queried for event information, and if the event information is predictable, the event information may be added to the gain value. For example, in the case of a two-dimensional map, if an event can be predicted by neighboring environmental agents in east, west, north, and south directions and for previous and next time periods, gains associated with the neighboring environmental agents may be added as a weighted gain to the gain value to obtain a new gain value G′(a_{x,t}, E) as follows:

$${G}_{neighbor} ( {a}_{x , t} , E ) = G ( {a}_{xnorth , t} , E ) + G ( {a}_{xsouth , t} , E ) + G ( {a}_{xeast , t} , E ) + G ( {a}_{xwest , t} , E ) + G ( {a}_{xnorth , t + 1} , E ) + G ( {a}_{xsouth , t + 1} , E ) + G ( {a}_{xeast , t} , E ) + G ( {a}_{xwest , t} , E ) + G ( {a}_{xnorth , t - 1} , E ) + G ( {a}_{xsouth , t - 1} , E ) + G ( {a}_{xeast , t - 1} , E ) + G ( {a}_{xwest , t - 1} , E )$$

$${G}^{′} ( {a}_{x , t} , E ) = G ( {a}_{x , t} , E ) + weight * {G}_{neighbor} ( {a}_{x , t} , E ) \vert 0 < weight < 1.$$

In some implementations, priority system 210 may query neighboring agents to predict an event's future state and may add this prediction to the gain value. For example, if neighboring agents indicate that the wildfire is spreading eastward, the gain value for the eastern neighboring agent would increase, reflecting the higher importance of acquiring new information in that direction. In some implementations, the priority system 210 may consider a type and the context of the information to adjust the gain value. Different types of information may have varying levels of importance, sensitivity, or volatility, which can impact the gain value. For example, if the information is related to a critical event, such as a natural disaster or a major incident, the gain value may be increased to reflect the importance of acquiring new information to support decision-making. Similarly, the context of the information can influence the gain value. For example, if the information is related to a specific location or region, the gain value may be adjusted based on the local conditions, such as weather, traffic, or other factors that may impact the accuracy or relevance of the information. In some implementations, the priority system 210 may integrate the gain value with other factors, such as the demand for the information, information entropy, and resource constraints. For example, if the demand for the information is high, and the information entropy is low, the priority system 210 may increase the gain value to reflect the potential benefit of acquiring new information to meet the demand.

As shown in FIG. 2C, and by reference number 230, the priority system 210 may calculate an information entropy for the information based on the context, a plurality of information acquisition methods, and an information fluctuation probability associated with the context. For example, the information entropy may represent an uncertainty or a randomness of the information, and may be utilized by the priority system 210 to quantify a potential benefit of acquiring new information. In some implementations, the information entropy (I) may include a value that is obtained from the context (X) and the plurality of information acquisition methods (M). The priority system 210 may calculate the information entropy (I) based on the context (X), the plurality of information acquisition methods (M), and the information fluctuation probability (P) associated with the context (X). The information fluctuation probability may represent a likelihood that the information will change or fluctuate over time, given the context. For example, in the context of a traffic monitoring system, the information fluctuation probability may be higher during rush hour or in areas with high construction activity, where traffic patterns are more likely to change rapidly. The priority system 210 may calculate the information fluctuation probability using various methods, such as historical analysis of past information, statistical models (e.g., Bayesian network models or Markov chain models), expert judgment based on domain knowledge and experience, and/or the like.

In some implementations, the priority system 210 may calculate the information entropy (I) based on the context (X), the plurality of information acquisition methods (M), and the information fluctuation probability (P) associated with the context (X) as follows:

I(X,M)=−log {(1−P(X,M))}.

where the greater the information fluctuation probability, the greater the information entropy. In some implementations, if new information cannot be acquired by the plurality of information acquisition methods (M), the information entropy (I) may not include a value. Whether the new information can be acquired may be determined for each of the plurality of information acquisition methods. For example, for vehicles, whether the new information can be acquired may be determined by a route search. For satellites, whether the new information can be acquired may be determined by an orbit of a satellite. In some implementations, the priority system 210 may adjust the information entropy based on the context. For example, if the context is highly dynamic, the information entropy may be increased to reflect the higher uncertainty and potential benefit of acquiring new information.

As shown in FIG. 2D, and by reference number 235, the priority system 210 may calculate, based on the gain value and the information entropy, an information value for each of the plurality of information acquisition methods to generate a plurality of information values. For example, the priority system 210 may calculate an information value for each of the plurality of information acquisition methods based on the gain value and the information entropy. The calculations may generate the plurality of information values. In some implementations, the information value (V) of an environmental agent a_{x,t} for an event type (E) and an information acquisition method (M) may be calculated using the gain (G) and the information entropy (I) as follows:

V(M,E)=G·I,

where the greater value of V, the more valuable the information. If the information entropy does not have a value, then the information value will not have a value. The information value may define a value of the information to be acquired, and may indicate whether it is meaningful to acquire the information.

In some implementations, the information value may represent an expected benefit of acquiring new information using a particular acquisition method, given the current uncertainty and potential gain. In some implementations, the priority system 210 may normalize the plurality of information values to ensure that the plurality of information values are on the same scale. This can be done using various methods, such as a min-max normalization method, a z-score normalization method, and/or the like. The priority system 210 may adjust the plurality of information values based on the context. For example, if the context is highly dynamic, the priority system 210 may increase the plurality of information values to reflect the higher uncertainty and potential benefit of acquiring new information.

As shown by FIG. 2E, and reference number 240, the priority system 210 may determine, based on the demand and each of the plurality of information values, a priority score for each of the plurality of information acquisition methods to generate a plurality of priority scores. For example, the priority system 210 may determine a priority score for each of the plurality of information acquisition methods based on the demand for the information and based on each of the plurality of information values. These determinations may generate the plurality of priority scores. A priority score may represent a relative importance of acquiring new information using a particular acquisition method, given the current demand for the information and an expected benefit.

In some implementations, the priority system 210 may determine a priority score for each of the plurality of information acquisition methods by multiplying the demand and one of the plurality of information values. Alternatively, the priority system 210 may determine a priority score for each of the plurality of information acquisition methods by dividing the demand by one of the plurality of information values. Alternatively, the priority system 210 may determine a priority score for each of the plurality of information acquisition methods by adding the demand and one of the plurality of information values. Alternatively, the priority system 210 may determine a priority score for each of the plurality of information acquisition methods by applying weights to the demand and one of the plurality of information values to generate a weighted demand and a weighted information value. The priority system 210 may add the weighted demand and the weighted information value to determine the priority score. In some implementations, the priority system 210 may normalize the plurality of priority scores to ensure that the plurality of priority scores are on the same scale. This can be done using various methods, such as a min-max normalization method, a z-score normalization method, and/or the like. The priority system 210 may adjust the priority scores based on the context. For example, if the context is highly dynamic, the priority scores may be increased to reflect the higher uncertainty and potential benefit of acquiring new information.

As shown by FIG. 2F, and reference number 245, the priority system 210 may perform the one or more actions based on the plurality of priority scores. In some implementations, performing the one or more actions includes the priority system 210 ranking the plurality of information acquisition methods based on the plurality of priority scores to generate a ranked list, and selecting an information acquisition method from the ranked list. For example, the priority system 210 may rank the plurality of information acquisition methods based on the plurality of priority scores, where an information acquisition method with a highest priority score may be ranked highest, followed by an information acquisition method with the next highest priority score, and so on. The ranking of the plurality of information acquisition methods may generate a ranked list, and the priority system 210 may select one of the plurality of information acquisition methods from the ranked list. For example, the priority system 210 may select the information acquisition method with the highest rank in the ranked list. In this way, the priority system 210 may conserve computing resources, networking resources, and/or the like that would otherwise have been consumed by failing to prioritize which information should be acquired and updated.

In some implementations, performing the one or more actions includes the priority system 210 causing the selected information acquisition method to be implemented for acquiring new information. For example, the selected information acquisition method may be associated with a system that causes new information to be acquired. The priority system 210 may instruct the system associated with the selected acquisition method to acquire the new information. In some implementations, the priority system 210 may provide acquisition requests to the system and the system may acquire the new information based on the acquisition requests. In this way, the priority system 210 may conserve computing resources, networking resources, and/or the like that would otherwise have been consumed by gathering useless information that is no longer relevant based on failing to prioritize which information should be acquired.

In some implementations, performing the one or more actions includes the priority system 210 providing the plurality of priority scores for display. For example, the priority system 210 may provide the plurality of priority scores for display to a user of the priority system 210. The user may utilize the plurality of priority scores to select one of the plurality of information acquisition methods, and to instruct a system associated with the selected acquisition method to acquire the new information. In some implementations, the user may provide acquisition requests to the system and the system may acquire the new information based on the acquisition requests. In this way, the priority system 210 may conserve computing resources, networking resources, and/or the like that would otherwise have been consumed by gathering useless information that is no longer relevant based on failing to prioritize which information should be acquired.

In some implementations, performing the one or more actions includes the priority system 210 selecting an information acquisition method based on the plurality of priority scores, and causing the selected information acquisition method to be implemented for acquiring new information. For example, the priority system 210 may select one of the plurality of information acquisition methods based on the plurality of priority scores (e.g., an information acquisition method associated with the greatest priority score). The priority system 210 may instruct the selected acquisition method to acquire the new information. In this way, the priority system 210 may conserve computing resources, networking resources, and/or the like that would otherwise have been consumed by failing to gather information that is urgently needed based on failing to prioritize which information should be acquired.

In some implementations, performing the one or more actions includes the priority system 210 instructing a system associated with the selected information acquisition methods to acquire the new information. For example, the selected information acquisition method may be associated with a system that causes new information to be acquired. The priority system 210 may instruct the system associated with the selected acquisition method to acquire the new information. In some implementations, the priority system 210 may provide acquisition requests to the system and the system may acquire the new information based on the acquisition requests. In this way, the priority system 210 may conserve computing resources, networking resources, and/or the like that would otherwise have been consumed by gathering useless information that is no longer relevant based on failing to prioritize which information should be acquired.

FIG. 2G depicts an example of an environmental agent that may be utilized with the priority system 210. As shown, the environmental agent may include an event demand (D) forecast function that forecasts an event demand from historical data, and a context (X) calculation function that calculates the context (X). The environmental agent may include a information value (14 calculation function that includes an information acquisition methods (M) management function, an information entropy (I) calculation function, and a gain (G) calculation function. The information entropy (I) calculation function may calculate the information entropy (I), and the gain (G) calculation function may calculate the gain (G). The information value (14 calculation function may calculate the information value (14 for each of the information acquisition methods (M) based on the information entropy (I) and the gain (G). The information value (14 calculation function may interact with an information acquisition method database and information acquisition method management features system.

As further shown in FIG. 2G, the environmental agent may include an event (E) management function that includes an event statistics management function, a neighborhood agent information sharing function, an event prediction function, a current and future events database, an event forecast acquisition function, and an event notification function. The event statistics management function may include historical data for an event activities database that provides the historical data to the event demand (D) forecast function and the context (X) calculation function. The neighborhood agent information sharing function may share agent information with the event prediction function. The event prediction function may receive historical data for event activities from the event statistics management function, may predict current and future events based on the historical data, and may store the predicted events in the current and future events database. The event forecast acquisition function may acquire event forecasts from third party forecast data sources. The event notification function may save event usage data as statistical information.

As further shown in FIG. 2G, the environmental agent may include a priority calculation component that calculates priority scores for the information acquisition methods (M) based on the event demand (D) and the information values (V). The priority calculation component may generate acquisition requests based on the priority scores, and may provide the acquisition requests to the information acquisition method management features system. The system may acquire the new information based on the acquisition requests.

In this way, the computer system (e.g., the priority system 210) determines information acquisition priorities based on age-of-information and demand. For example, the computer system may optimize information acquisition by reducing latency and increasing the relevance of the acquired information. The computer system may scale back unnecessary information gathering operations, thus reducing data transmission overhead and conserving bandwidth. By calculating priority scores for different information acquisition methods, the computer system may enable more efficient allocation of system resources, such as processing power and memory. Thus, the computer system conserves computing resources, networking resources, and/or the like that would otherwise have been consumed by failing to prioritize which information should be acquired and updated, gathering useless information that is no longer relevant based on failing to prioritize which information should be acquired, failing to gather information that is urgently needed based on failing to prioritize which information should be acquired, and/or the like.

As indicated above, FIGS. 2A-2G are provided as an example. Other examples may differ from what is described with regard to FIGS. 2A-2G. The number and arrangement of devices shown in FIGS. 2A-2G are provided as an example. In practice, there may be additional devices, fewer devices, different devices, or differently arranged devices than those shown in FIGS. 2A-2G. Furthermore, two or more devices shown in FIGS. 2A-2G may be implemented within a single device, or a single device shown in FIGS. 2A-2G may be implemented as multiple, distributed devices. Additionally, or alternatively, a set of devices (e.g., one or more devices) shown in FIGS. 2A-2G may perform one or more functions described as being performed by another set of devices shown in FIGS. 2A-2G.

FIG. 3 is a flowchart of an example process 300 associated with determining information acquisition priorities based on age-of-information and demand. One or more process blocks of FIG. 3 are performed by a computer system (e.g., computer 102, the priority system 210, and/or the like) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or priority generation code 150.

As shown in FIG. 3, process 300 may include receiving an age-of-information and a demand for information to be utilized in an application (block 310). For example, the computer system may receive an age-of-information and a demand for information to be utilized in an application, as described above. In some implementations, the information includes geographic information and time information associated with events. In some implementations, the age-of-information is calculated based on a time elapsed since a last update of the information. In some implementations, the demand is calculated based on a number of times that the information has been referenced in a past time period.

As further shown in FIG. 3, process 300 may include determining a context for the information based on one or more external factors that influence variation of the information (block 320). For example, the computer system may determine a context for the information based on one or more external factors that influence variation of the information, as described above.

As further shown in FIG. 3, process 300 may include calculating a gain value for the information based on the age-of-information (block 330). For example, the computer system may calculate a gain value for the information based on the age-of-information, as described above.

As further shown in FIG. 3, process 300 may include calculating an information entropy for the information based on the context, a plurality of information acquisition methods, and an information fluctuation probability associated with the context (block 340). For example, the computer system may calculate an information entropy for the information based on the context, a plurality of information acquisition methods, and an information fluctuation probability associated with the context, as described above. In some implementations, the information fluctuation probability is calculated based on a type and a location associated with the information. In some implementations, the plurality of information acquisition methods includes one or more of a satellite-based information acquisition method, a drone-based information acquisition method, an autonomous vehicle-based information acquisition method, or a traffic infrastructure-based information acquisition method.

As further shown in FIG. 3, process 300 may include calculating, based on the gain value and the information entropy, an information value for each of the plurality of information acquisition methods to generate a plurality of information values (block 350). For example, the computer system may calculate, based on the gain value and the information entropy, an information value for each of the plurality of information acquisition methods to generate a plurality of information values, as described above.

As further shown in FIG. 3, process 300 may include determining, based on the demand and each of the plurality of information values, a priority score for each of the plurality of information acquisition methods to generate a plurality of priority scores (block 360). For example, the computer system may determine, based on the demand and each of the plurality of information values, a priority score for each of the plurality of information acquisition methods to generate a plurality of priority scores, as described above.

As further shown in FIG. 3, process 300 may include performing one or more actions based on the plurality of priority scores (block 370). For example, the computer system may perform one or more actions based on the plurality of priority scores, as described above. In some implementations, performing the one or more actions comprises ranking the plurality of information acquisition methods based on the plurality of priority scores to generate a ranked list, and selecting one of the plurality of information acquisition methods from the ranked list. In some implementations, process 300 includes causing the one of the plurality of information acquisition methods to be implemented for acquiring new information to be utilized in the application.

In some implementations, performing the one or more actions comprises providing the plurality of priority scores for display. In some implementations, performing the one or more actions comprises selecting one of the plurality of information acquisition methods based on the plurality of priority scores, and causing the one of the plurality of information acquisition methods to be implemented for acquiring new information to be utilized in the application. In some implementations, causing the one of the plurality of information acquisition methods to be implemented includes instructing a system associated with the one of the plurality of information acquisition methods to acquire the new information to be utilized in the application.

In some implementations, process 300 includes receiving an indication that one of the plurality of information acquisition methods is unavailable, and adjusting one of the plurality of priority scores corresponding to the one of the plurality of information acquisition methods based on the indication. In some implementations, process 300 includes receiving an indication indicating one or more changes in the information, and adjusting the plurality of priority scores based on the indication.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DV D), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
receiving an age-of-information and a demand for information to be utilized in an application;
determining a context for the information based on one or more external factors that influence variation of the information;
calculating a gain value for the information, wherein the information is associated with a location, and wherein calculating the gain value comprises adjusting, based on event information for the location, an initial gain value for the information that is based on the age-of-information to generate the gain value;
calculating an information entropy for the information based on the context, a plurality of information acquisition methods, and an information fluctuation probability associated with the context, wherein calculating the information entropy comprises determining, for each respective information acquisition method of the plurality of information acquisition methods, whether new information is acquirable by the respective information acquisition method based on an operational state of a system associated with the respective information acquisition method, and for an information acquisition method of the plurality of information acquisition methods by which the new information is determined to be not acquirable, setting the information entropy for the information acquisition method to zero;
calculating, based on the gain value and the information entropy, an information value for each of the plurality of information acquisition methods to generate a plurality of information values;
determining, based on the demand and each of the plurality of information values, a priority score for each of the plurality of information acquisition methods to generate a plurality of priority scores; and
performing one or more actions based on the plurality of priority scores, wherein performing the one or more actions comprises instructing a system associated with one of the plurality of information acquisition methods, selected based on the plurality of priority scores, to acquire the new information to be utilized in the application.

2. The method of claim 1, wherein performing the one or more actions comprises:
ranking the plurality of information acquisition methods based on the plurality of priority scores to generate a ranked list; and
selecting the one of the plurality of information acquisition methods from the ranked list.

3. (canceled)

4. The method of claim 1, wherein performing the one or more actions comprises:
providing the plurality of priority scores for display.

5. (canceled)

6. (canceled)

7. The method of claim 1, wherein the information includes geographic information and time information associated with events.

8. A computer system, comprising:
a processor set;
one or more computer-readable storage media; and
program instructions stored on the one or more computer-readable storage media to cause the processor set to perform operations comprising:
receiving an age-of-information and a demand for information to be utilized in an application, wherein the information includes geographic information and time information associated with events;
determining a context for the information based on one or more external factors that influence variation of the information;
calculating a gain value for the information, wherein the information is associated with a location, and wherein calculating the gain value comprises adjusting, based on event information for the location, an initial gain value for the information that is based on the age-of-information to generate the gain value;
calculating an information entropy for the information based on the context, a plurality of information acquisition methods, and an information fluctuation probability associated with the context, wherein calculating the information entropy comprises determining, for each respective information acquisition method of the plurality of information acquisition methods, whether new information is acquirable by the respective information acquisition method based on an operational state of a system associated with the respective information acquisition method, and for an information acquisition method of the plurality of information acquisition methods by which the new information is determined to be not acquirable, setting the information entropy for the information acquisition method to zero;
calculating, based on the gain value and the information entropy, an information value for each of the plurality of information acquisition methods to generate a plurality of information values;
determining, based on the demand and each of the plurality of information values, a priority score for each of the plurality of information acquisition methods to generate a plurality of priority scores; and
performing one or more actions based on the plurality of priority scores, wherein performing the one or more actions comprises instructing a system associated with one of the plurality of information acquisition methods, selected based on the plurality of priority scores, to acquire the new information to be utilized in the application.

9. The computer system of claim 8, wherein the age-of-information is calculated based on a time elapsed since a last update of the information.

10. The computer system of claim 8, wherein the information fluctuation probability is calculated based on a type and a location associated with the information.

11. The computer system of claim 8, wherein the demand is calculated based on a number of times that the information has been referenced in a past time period.

12. The computer system of claim 8, wherein the plurality of information acquisition methods include one or more of a satellite-based information acquisition method, a drone-based information acquisition method, an autonomous vehicle-based information acquisition method, or a traffic infrastructure-based information acquisition method.

13. The computer system of claim 8, wherein the operations further comprise:
receiving an indication that an additional one of the plurality of information acquisition methods is unavailable; and
adjusting one of the plurality of priority scores corresponding to the additional one of the plurality of information acquisition methods based on the indication.

14. The computer system of claim 8, wherein the operations further comprise:
receiving an indication indicating one or more changes in the information; and
adjusting the plurality of priority scores based on the indication.

15. A computer program product, comprising:
a processor set;
one or more computer-readable storage media; and
program instructions stored on the one or more computer-readable storage media to cause the processor set to perform operations comprising:
receiving an age-of-information and a demand for information to be utilized in an application, wherein the age-of-information is calculated based on a time elapsed since a last update of the information;
determining a context for the information based on one or more external factors that influence variation of the information;
calculating a gain value for the information, wherein the information is associated with a location, and wherein calculating the gain value comprises adjusting, based on event information for the location, an initial gain value for the information that is based on the age-of-information to generate the gain value;
calculating an information entropy for the information based on the context, a plurality of information acquisition methods, and an information fluctuation probability associated with the context, wherein calculating the information entropy comprises determining, for each respective information acquisition method of the plurality of information acquisition methods, whether new information is acquirable by the respective information acquisition method based on an operational state of a system associated with the respective information acquisition method, and for an information acquisition method of the plurality of information acquisition methods by which the new information is determined to be not acquirable, setting the information entropy for the information acquisition method to zero;
calculating, based on the gain value and the information entropy, an information value for each of the plurality of information acquisition methods to generate a plurality of information values;
determining, based on the demand and each of the plurality of information values, a priority score for each of the plurality of information acquisition methods to generate a plurality of priority scores; and
performing one or more actions based on the plurality of priority scores, wherein performing the one or more actions comprises instructing a system associated with one of the plurality of information acquisition methods, selected based on the plurality of priority scores, to acquire the new information to be utilized in the application.

16. The computer program product of claim 15, wherein performing the one or more actions comprises:
ranking the plurality of information acquisition methods based on the plurality of priority scores to generate a ranked list; and
selecting the one of the plurality of information acquisition methods from the ranked list.

17. The computer program product of claim 15, wherein performing the one or more actions comprises:
providing the plurality of priority scores for display.

18. (canceled)

19. The computer program product of claim 15, wherein the operations further comprise:
receiving an indication that an additional one of the plurality of information acquisition methods is unavailable; and
adjusting one of the plurality of priority scores corresponding to the additional one of the plurality of information acquisition methods based on the indication.

20. The computer program product of claim 15, wherein the operations further comprise:
receiving an indication indicating one or more changes in the information; and
adjusting the plurality of priority scores based on the indication.

21. The method of claim 1, further comprising:
receiving the event information for the location from one or more agents associated with one or more neighboring locations of the location, wherein adjusting the initial gain value is based at least in part on reception of the event information.

22. The method of claim 21, wherein the one or more neighboring locations are associated with one or more directions relative to the location and one or more time periods relative to a time period associated with the location, and wherein adjusting the initial gain value comprises adding, as a weighted gain, one or more gains associated with the one or more agents to the initial gain value.

23. The method of claim 22, wherein the event information indicates that an event is spreading toward a neighboring location of the one or more neighboring locations, and wherein adjusting the initial gain value comprises increasing the initial gain value for the neighboring location toward which the event is spreading, as indicated by the event information from an agent associated with the neighboring location.

24. The method of claim 1, further comprising:
receiving an indication indicating one or more changes in the information; and
adjusting the plurality of priority scores based on the indication.
